(19) United States
(12) Patent Application Publication
(10) Pub. No.: US 2014/0168575 A1
(43) Pub. Date: Jun. 19, 2014

(54) LIQUID CRYSTAL DISPLAY

(71) Applicant: RADIANT OPTO-ELECTRONICS CORPORATION, Kaohsiung (TW)

(72) Inventor: Yi-Tsuo WU, KAOHSIUNG (TW)

(73) Assignee: RADIANT OPTO-ELECTRONICS CORPORATION, KAOHSIUNG (TW)

(21) Appl. No.: 13/846,817

(22) Filed: Mar. 18, 2013

(30) Foreign Application Priority Data
Dec. 19, 2012 (TW) 101148365

(51) Int. Cl. G02F 1/1335

(52) U.S. Cl. CPC G02F 1/133603
USPC 349/65

(57) ABSTRACT

A liquid crystal display is described, which includes a backlight module and a liquid crystal display panel. The backlight module includes a light guide plate and a plurality of blue light-emitting diodes adjacent to the light guide plate. The liquid crystal display panel is disposed above the backlight module. The liquid crystal display panel includes a first transparent substrate, a first electrode, a liquid crystal layer, a phosphor powder layer, a color filter, a second electrode and a second transparent substrate stacked above the light guide plate in sequence. The phosphor powder layer includes a plurality of green phosphor powder regions and red phosphor powder regions. The color filter is adjacent to the phosphor powder layer. The color filter includes a plurality of green color filter regions and red color filter regions respectively and correspondingly located, on the green phosphor powder regions and the red phosphor powder regions.

### RELATED APPLICATIONS

This application claims priority to Taiwan Application Serial Number 101148365, filed Dec. 19, 2012, which are herein incorporated by reference.

### FIELD OF THE INVENTION

The present invention relates to a flat panel display device, and more particularly to a liquid crystal display (LCD).

### BACKGROUND OF THE INVENTION

Refer to FIG. 1. FIG. 1 is a schematic diagram showing a conventional liquid crystal display. A liquid crystal display 100 mainly includes a backlight module 102 and a liquid crystal display panel 104. The backlight module 102 is disposed on a rear side of the liquid crystal display panel 104 to provide the liquid crystal display panel 104 with light. The backlight module 102 typically includes a light guide plate 106 and a plurality of light-emitting diodes (LEDs) 120. The light-emitting diodes 120 are disposed beside a side surface of the light guide plate 106. Each light-emitting diode 120 includes a light-emitting diode chip 108 and a phosphor powder layer 110 covering the light-emitting diode chip 108.

The liquid crystal display panel 104 mainly includes a first glass substrate 112, a liquid crystal layer 114, a color filter 116 and a second glass substrate 118. As shown in FIG. 1, the liquid crystal layer 114, the color filter 116 and the second glass substrate 118 are stacked on the first glass substrate 112 in sequence.

In the current liquid crystal display 100, the light-emitting diodes 120 are usually white light light-emitting diodes. However, the light-emitting diode chips 108 are manufactured by an epitaxy process. The epitaxy process is complicated, so that the light-emitting diode chips 108 manufactured on the same wafer cannot have identical photoelectric property. For example, the light-emitting diode chips 108 may have different brightness or different wavelengths. In addition, the light-emitting diodes 120 formed after the light-emitting diode chips 108 are packaged may have different wavelengths due to the effect of the phosphor powder layer 110.

In the fabrication of the liquid crystal display 100, the uniformity of white light of the light-emitting diodes 120 is required strictly. Therefore, after the white light light-emitting diodes 120 are completed, a part of the white light light-emitting diodes 120, which do not conform to the color requirement, are abandoned by manufacturers through a bin-sorting procedure, thereby increasing the fabrication cost.

Furthermore, in the current light-emitting diode 120, the phosphor powder layer 110, which is formed by mixing phosphor powders and glue, usually directly covers the light-emitting diode chip 108. As a result, the light-emitting diode chip 108 is very close to the phosphor powders in the phosphor powder layer 110. However, the luminescence efficiency of the phosphor powders is affected by heat, and the heat is generated when the current passes through the light-emitting diode 120, so that the luminescence efficiency of the phosphor powders is directly affected to lower the luminescence efficiency of the light-emitting diode 120.

In addition, the chromatic dispersion of the light emitted by the white light light-emitting diodes 120 is usually occurred after the light is transmitted for a certain distance by the light guide plate 106. Therefore, the color distribution of the entire emitting-light of the light guide plate 106 is non-uniform.

Moreover, the light provided by the backlight module 102 is white light, so that it is necessary to use the color filter 116, which includes color filter regions of three colors, such as red, green and blue, or color filter regions of four colors, such as red, green, blue and yellow, to generate the light of the desired color. However, the color filter region of each color has a specific absorptivity to the white light. Currently, the transmittance of the color filter 116 for the white light emitted by the white light light-emitting diodes 120 is less than 10%. Therefore, the utilization efficiency of the light emitted by the light-emitting diodes 120 is poor.

Refer to FIG. 2. FIG. 2 is a schematic diagram showing another conventional liquid crystal display. A liquid crystal display 200 mainly includes a backlight module 202 and a liquid crystal display panel 204. The backlight module 202 is disposed on a rear side of the liquid crystal display panel 204. The backlight module 202 includes a plurality of blue light-emitting diodes 206 and a diffusing plate 208. The diffusing plate 208 is disposed above the blue light-emitting diodes 206 to uniformly diffuse the blue light emitted by the blue light-emitting diodes 206.

The liquid crystal display panel 204 mainly includes a phosphor powder layer 210, a first glass substrate 216, a first electrode 218, a liquid crystal layer 220, a second electrode 222 and a second glass substrate 224 stacked in sequence. The phosphor powder layer 210 includes a plurality of red phosphor powder regions 212, a plurality of green phosphor powder regions 214 and a plurality of opening regions 226. The red phosphor powder regions 212, the green phosphor powder regions 214 and the opening regions 226 are staggered sequentially.

The red phosphor powder regions 212 and the green phosphor powder regions 214 are excited by the blue light emitted by the blue light-emitting diodes 206 to respectively emit red light and green light. On the other hand, after the blue light passes through the opening regions 226, the blue light is naturally emitted. Accordingly, the liquid crystal display 200 has a RGB color system.

However, the blue light emitted by the blue light-emitting diodes 206 is spherically scattered in space. Therefore, the red light and the green light formed by the excitation of the blue light are spherically scattered in space. Therefore, such as shown in dotted line boxes 228 and 230 in FIG. 2, after passing through the liquid crystal layer 220, the red light and the green light may illuminate adjacent pixels, such that the adjacent pixels are contaminated by the red light or the green light.

### SUMMARY OF THE INVENTION

Therefore, one aspect of the present invention is to provide a liquid crystal display, which uses blue light-emitting diodes as light sources. Accordingly, a bin yield loss during packaging caused by using white light-emitting diodes is eliminated, and a utilization rate of the light-emitting diodes is increased, thereby reducing a fabrication cost of the liquid crystal display.

Another aspect of the present invention is to provide a liquid crystal display, in which color purity of blue light-emitting diodes used as light sources is high, and a chromatic aberration problem is not occurred even the blue light emitted by the light-emitting diodes penetrates the entire light guide plate, so that a color distribution of the whole emitted light of the light guide plate is very uniform.

Still another aspect of the present invention is to provide a liquid crystal display, in which no blue color filter region is needed, so that a fabrication cost is decreased, and optical efficiency of blue light of blue pixels is enhanced.

Further another aspect of the present invention is to provide a liquid crystal display, in which while passing through green color filter regions, a conversion ratio from blue light to green light is increased by adjusting a concentration of green phosphor powders. Therefore, utilization efficiency and color purity of the green light are increased.

Yet another aspect of the present invention is to provide a liquid crystal display, in which phosphor powders do not contact with light-emitting diode chips, so that it can prevent the reduction of optical conversion efficiency, which is caused by heat generated while the light-emitting diode chips are operating.

Still further another aspect of the present invention is to provide a liquid crystal display, in which a phosphor structure is composed of discontinuous phosphor dots rather than a phosphor powder layer covering a light guide plate. Therefore, the liquid crystal display has a small usage amount of phosphor materials and high luminescence efficiency.

Still yet another aspect of the present invention is to provide a liquid crystal display, which has higher color gamut.

According to the aforementioned aspects, the present invention provides a liquid crystal display. The liquid crystal display includes a backlight module and a liquid crystal display panel. The backlight module includes a light guide plate and a plurality of blue light-emitting diodes. The blue light-emitting diodes are adjacent to a side surface of the light guide plate to emit blue light toward the light guide plate through the side surface. The liquid crystal display panel is disposed above a front surface of the backlight module. The liquid crystal display panel includes a first transparent substrate, a first electrode, a liquid crystal layer, a phosphor powder layer, a color filter, a second electrode and a second transparent substrate. The first transparent substrate is disposed above the light guide plate. The first electrode is disposed on the first transparent substrate. The liquid crystal layer is disposed on the first electrode. The phosphor powder layer is disposed on the liquid crystal layer, in which the phosphor powder layer includes a plurality of green phosphor powder regions and a plurality of red phosphor powder regions. The color filter is disposed on the phosphor powder layer and adjacent to the phosphor powder layer. The color filter includes a plurality of green color filter regions and a plurality of red color filter regions respectively and correspondingly located on the green phosphor powder regions and the red phosphor powder regions. The second electrode is disposed on the color filter. The second transparent substrate is disposed on the second electrode.

According to a preferred embodiment of the present invention, each of the first transparent substrate and the second transparent substrate is a glass substrate.

According to another preferred embodiment of the present invention, the phosphor powder layer further includes a plurality of opening regions, and the opening regions, the green phosphor powder regions and the red phosphor powder regions are staggered sequentially.

According to still another preferred embodiment of the present invention, the color filter further includes a plurality of blue color filter regions respectively and correspondingly located on the opening regions.

According to further another preferred embodiment of the present invention, the color filter further includes a plurality of blue light opening regions respectively and correspondingly located on the opening regions.

According to yet another preferred embodiment of the present invention, the phosphor powder layer further includes a plurality of yellow phosphor powder regions and a plurality of opening regions, and the opening regions, the green phosphor powder regions, the red phosphor powder regions and the yellow phosphor powder regions are staggered sequentially. In addition, the color filter further includes a plurality of yellow color filter regions respectively and correspondingly located on the yellow phosphor powder regions.

According to still further another preferred embodiment of the present invention, the color filter further includes a plurality of blue color filter regions respectively and correspondingly located on the opening regions.

According to still yet another preferred embodiment of the present invention, the color filter further includes a plurality of blue light opening regions respectively and correspondingly located on the opening regions.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1 is a schematic diagram showing a conventional liquid crystal display;

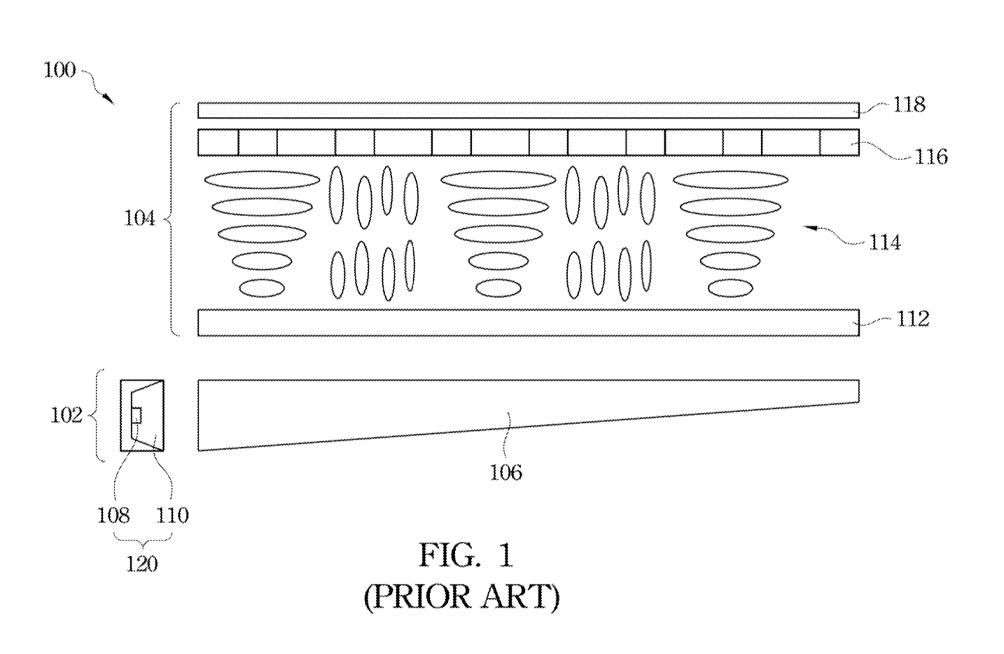

FIG. 2 is a schematic diagram showing another conventional liquid crystal display;

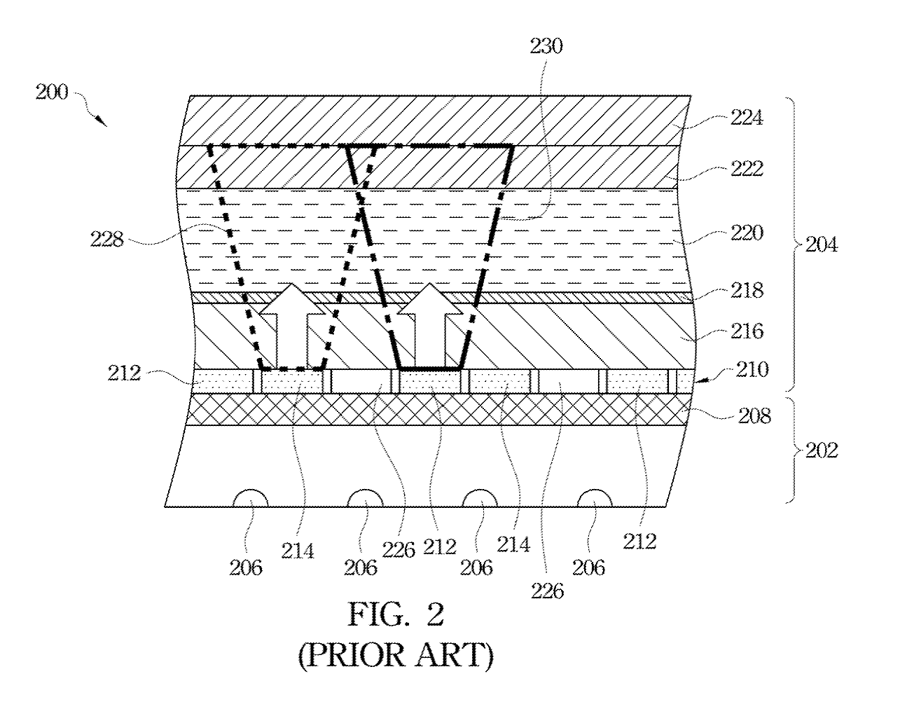

FIG. 3 is a schematic diagram showing a liquid crystal display in accordance with an embodiment of the present invention;

FIG. 4A is a spectrogram of light having passed through red phosphor powder regions in accordance with an embodiment of the present invention;

FIG. 4B is a spectrogram of light having passed through green phosphor powder regions in accordance with an embodiment of the present invention;

FIG. 5 is a comparative diagram of color ranges of a liquid crystal display in accordance with an embodiment of the present invention and a conventional liquid crystal display using white light light-emitting diodes;

FIG. 6 is a schematic diagram showing a liquid crystal display in accordance with another embodiment of the present invention; and

FIG. 7 is a comparative diagram of color ranges of a liquid crystal display in accordance with another embodiment of the present invention and a conventional liquid crystal display using white light light-emitting diodes.

### DETAILED DESCRIPTION OF THE PREFERRED EMBODIMENT

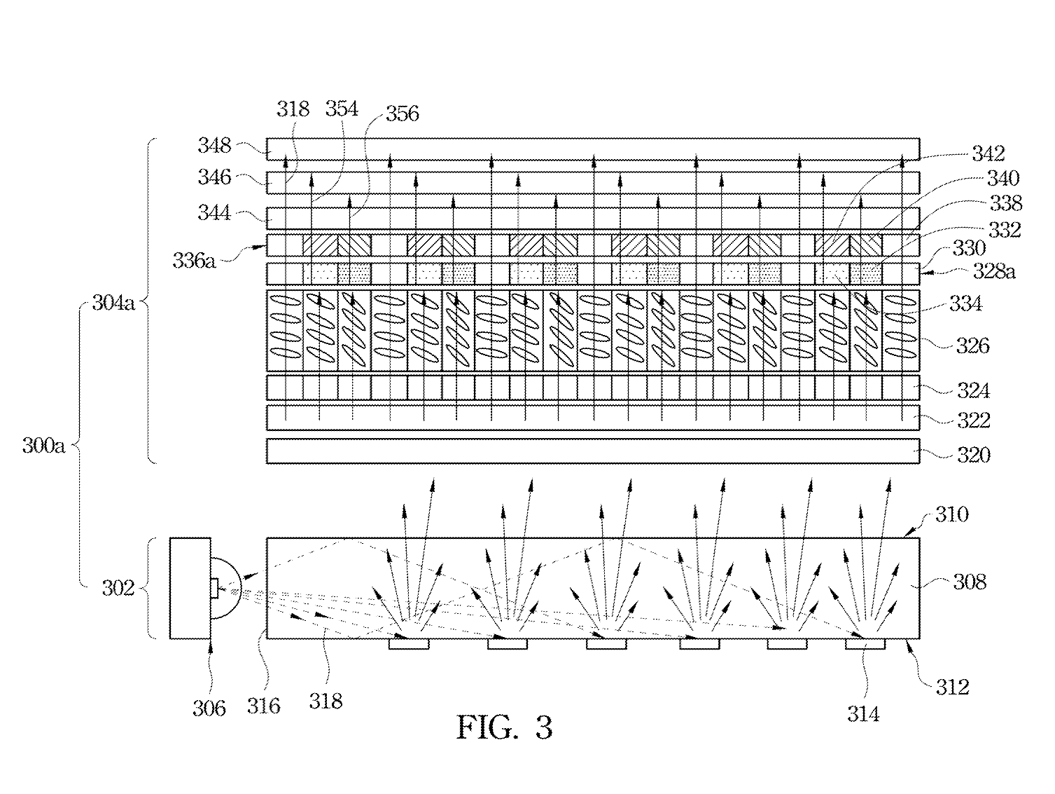

In viewing of the aforementioned conditions, the present application provides a liquid crystal display design to prevent the aforementioned disadvantages of the conventional liquid crystal display. Refer to FIG. 3. FIG. 3 is a schematic diagram showing a liquid crystal display in accordance with an embodiment of the present invention. In the present embodiment, a liquid crystal display 300a mainly includes a backlight module 302 and a liquid crystal display panel 304a. The backlight module 302 mainly includes a plurality of blue light-emitting diodes 306 and a light guide plate 308. The light guide plate 308 is a transparent plate body, which can transmit light. The light guide plate 308 includes a light-entering surface 316, a light-emitting surface 310 and a reflective surface 312. The light-emitting surface 310 and the reflective surface 312 are opposite to each other, and the light-entering surface 316 is connected to one edge of the light-emitting surface 310 and one edge of the reflective surface 312. Many microstructures 314, such as dot structures, may be set on the reflective surface 312.

The blue light-emitting diodes 306 are adjacent to a side surface of the light guide plate 308, i.e. the light-entering surface 316, and can emit blue light 318 toward the light guide plate 308 through the light-entering surface 316. The blue light 318 can go forward within the light guide plate 308 by a total reflection method. The microstructures 314 on the reflective surface 312 can destroy the total reflection of the blue light 318 to reflect the blue light 318 toward the light-emitting surface 310 and to make the blue light 318 be emitted out of the light guide plate 308 from the light-emitting surface 310.

The liquid crystal display panel 304a is disposed above a front surface of the backlight module 302, i.e. a light-emitting surface 310 of the light guide plate 308. In one exemplary embodiment, the liquid crystal display panel 304a mainly includes a first transparent substrate 322, a first electrode 324, a liquid crystal layer 326, a phosphor powder layer 328a, a color filter 336a, a second electrode 344 and a second transparent substrate 346. The first transparent substrate 322 is disposed above the light-emitting surface 310 of the light guide plate 308. The first transparent substrate 322 may be a glass substrate, for example. The first electrode 324 is stacked on the first transparent substrate 322. The liquid crystal layer 326 covers the first electrode 324.

The phosphor powder layer 328a is disposed on the liquid crystal layer 326. In one exemplary embodiment, the phosphor powder layer 328a may include a plurality of green phosphor powder regions 334 and a plurality of red phosphor powder regions 332. As shown in FIG. 3, the phosphor powder layer 328a may further include a plurality of opening regions 330. The opening regions 330 are the regions, which are not filled with phosphor powders. The opening regions 330, the green phosphor powder regions 334 and the red phosphor powder regions 332 are staggered sequentially. For example, following one opening region 330, one green phosphor powder region 334 may be firstly arranged, one red phosphor powder region 332 is then arranged following the green phosphor powder region 334, and the following arrangements are proceeded in the same sequence.

The color filter 336a is disposed on the phosphor powder layer 328a and is adjacent to the phosphor powder layer 328a. In one exemplary embodiment, the color filter 336a may include a plurality of green color filter regions 342 and a plurality of red color filter regions 340. The green color filter regions 342 are respectively and correspondingly located on the green phosphor powder regions 334 of the phosphor powder layer 328a, and the red color filter regions 340 are respectively and correspondingly located on the red phosphor powder regions 332. In another word, the sizes and the positions of the green color filter regions 342 respectively correspond to the sizes and the positions of the underlying green phosphor powder regions 334, and the sizes and the positions of the red color filter regions 340 respectively correspond to the sizes and the positions of the underlying red phosphor powder regions 332.

In another exemplary embodiment, the color filter 336a may further include a plurality of blue light opening regions 338. The blue light opening regions 338 are the regions, which are not set with filter materials and can he directly passed through by the blue light. In still another exemplary embodiment, it may use blue color filter regions to replace the blue light opening regions 338 in the color filter 336a. The blue color filter regions can filter the blue light in the incident light passing therethrough. The blue light opening regions 338 or the blue color filter regions are respectively and correspondingly located on the opening regions 330 of the phosphor powder layer 328a. In another word, the sizes and the positions of the blue light opening regions 338 or the blue color filter regions respectively correspond to the sizes and the positions of the underlying opening regions 330.

The second electrode 344 is disposed on the color filter 336a. The second transparent substrate 346 is disposed on the second electrode 344. The second transparent substrate 346 may be similarly a glass substrate, for example. In some exemplary embodiments, according to the optical requirements, the liquid crystal display 300a may selectively include a first polarization plate 320 and a second polarization plate 348. The first polarization plate 320 is disposed between the first transparent substrate 322 and the backlight module 302. On the other hand, the second polarization plate 348 is disposed on the second transparent substrate 346.

In the liquid crystal display 300a, after being transmitted by the light guide plate 308, the blue light 318 emitted by the blue light-emitting diodes 306 of the backlight module 302 emits toward the overlying liquid crystal display panel 304a through the light-emitting surface 310. After being polarized by the first polarization plate 320, the blue light sequentially passes through the first transparent substrate 322, the first electrode 324 and the liquid crystal layer 326, and emits toward the phosphor powder layer 328a. The wavelength of the blue light 318 is shorter, so that the blue light 318 can excite the red powders of the red phosphor powder regions 332 and the green powders of the green phosphor powder regions 334 in the phosphor powder layer 328a to respectively generate red light 356 and green light 354. On the other hand, the blue light 318 directly passes through the opening regions 330 of the phosphor powder layer 328a.

The red light 356 and the green light 354 generated after the blue light 318 passes through the phosphor powder layer 328a can be respectively filtered by the red filter regions 340 and the green filter regions 342 of the overlying color filter 336a to emit the purer red light 356 and the purer green light 354. The blue light 318 passing through the phosphor powder layer 328a can directly pass through the blue light opening regions 338, or can be filtered by the blue color filter regions to emit the blue light 318. The red light 356, the green light 354 and the blue light 318 pass through the second transparent substrate 346 and the second polarization plate 348 to form the desired colors on a display surface of the liquid crystal display 300a.

In the liquid crystal display 300a, the phosphor powder layer 328a is closely adjacent to the color filter 336a, and the phosphor powder layer 328a and the color filter 336a are disposed above the liquid crystal layer 326, so that much of the red light 356, the green light 354 and the blue light 318 emitted from the phosphor powder layer 328a can respectively and directly emit toward the red color filter regions 340, the green color filter regions 342 and the blue light opening regions 338/blue color filter regions of the color filter 336a. Therefore, the optical utilization efficiency of the liquid crystal display 300a can be greatly enhanced.

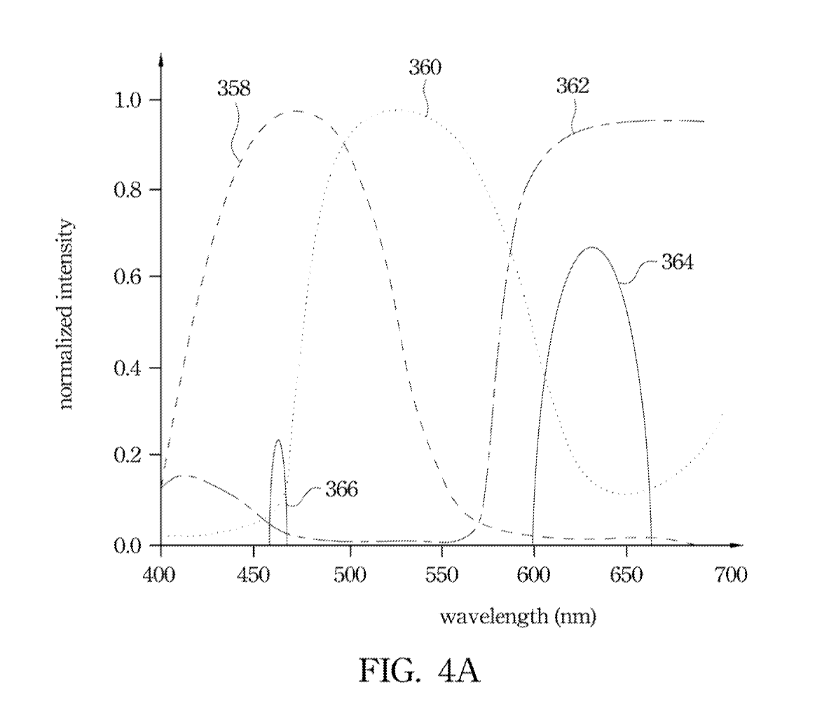

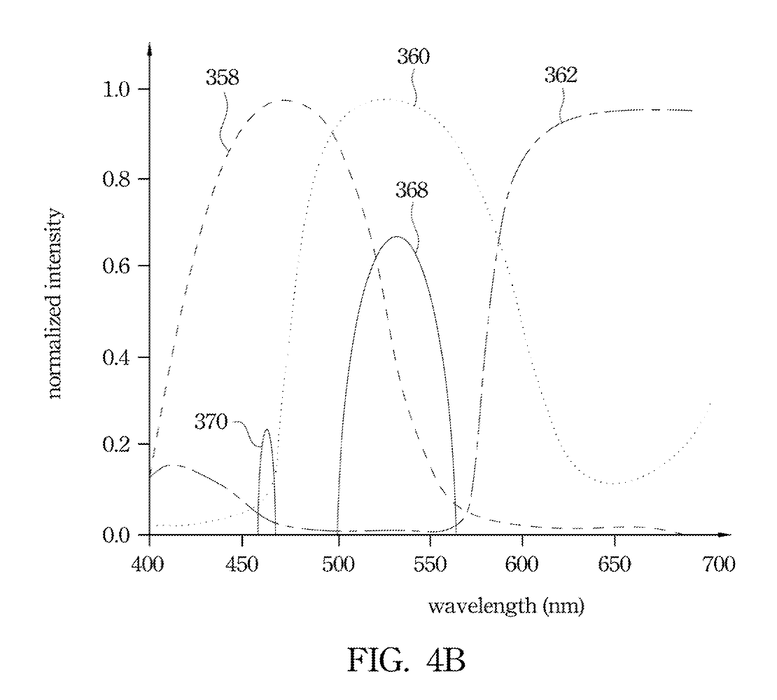

In addition, simultaneously refer to FIG. 3, FIG. 4A and FIG. 4B. FIG. 4A and FIG. 4B are spectrograms of light respectively having passed through red phosphor powder regions and green phosphor powder regions in accordance with an embodiment of the present invention. In the FIG. 4A and FIG. 4B, curves 358, 360 and 362 respectively represent transmittances of lights with various wavelengths to a blue color filter, a green color filter and a red color filter.

According to the spectrum curves 364 and 366 shown in FIG. 4A, it is known that after passing through the red phosphor powder regions 332 of the phosphor powder layer 328a, much of the blue light 318 excites the red light 356, but there is still little blue light 318 emitted along with the red light 356. The wavelengths of the light in the spectrum curve 364 are almost in the range, which can penetrate the red color filter, and the wavelengths of the light in the spectrum curve 366 are almost in the range, which has very poor transmittance to the red color filter, so that after passing through the red filter regions 340 of the color filter 336a, it can generate the red light 356 with higher color purity.

In addition, according to the spectrum curves 368 and 370 shown in FIG. 4B, it is known that after passing through the green phosphor powder regions 334, much of the blue light 318 excites the green light 354, but there is still little blue light 318 emitted along with the green light 354. The wavelengths of the light in the spectrum curve 368 are almost in the range, which can penetrate the green color filter, and the wavelengths of the light in the spectrum curve 370 are almost in the range, which has very poor transmittance to the green color filter, so that after passing through the green filter regions 342 of the color filter 336a, it can generate the green light 354 with higher color purity.

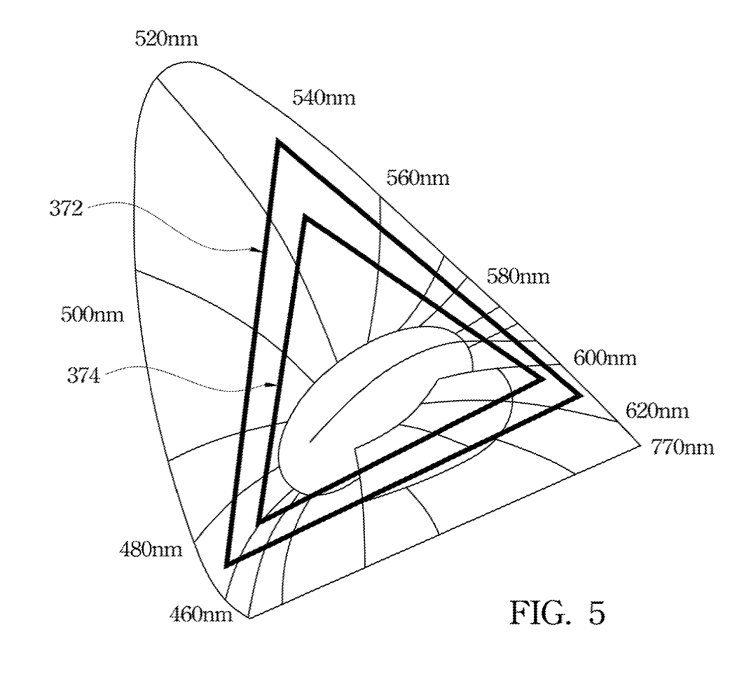

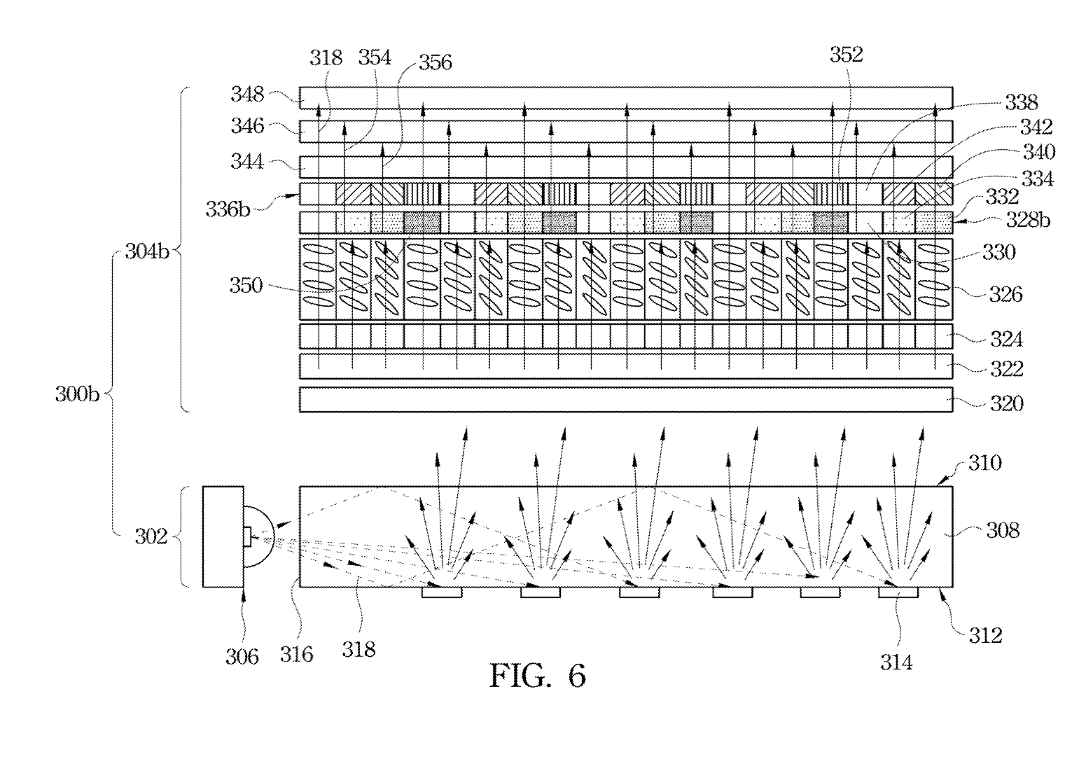

Refer to FIG, 5. FIG, 5 is a comparative diagram of color ranges of a liquid crystal display in accordance with an embodiment of the present invention and a conventional liquid crystal display using white light light-emitting diodes. According to FIG. 5, it is known that a color range 372, which the liquid crystal display 300a can show, is obviously larger than a color range 374, which the conventional liquid crystal display using the white light light-emitting diodes can show. Therefore, the color gamut of the liquid crystal display 300a is obviously superior to that of the conventional liquid crystal display using white light light-emitting diodes. Refer to FIG. 6. FIG. 6 is a schematic diagram showing a liquid crystal display in accordance with another embodiment of the present invention. In the present embodiment, a structure of a liquid crystal display 300b is substantially similar to that of the liquid crystal display 300a in the aforementioned embodiment. The main differences between the liquid crystal displays 300b and 300a are that the phosphor powder layer 328b of a liquid crystal display panel 304b further includes a plurality of yellow phosphor powder regions 350, and the color filter 336b further includes a plurality of yellow color filter regions 352.

As shown in FIG. 6, in the liquid crystal display 304b, the opening regions 330, the green phosphor powder regions 334, the red phosphor powder regions 332 and the yellow phosphor powder regions 350 are staggered sequentially. For example, following one opening region 330, one green phosphor powder region 334 may he firstly arranged, one red phosphor powder region 332 is next arranged following the green phosphor powder region 334 yellow phosphor powder region 350 is then arranged following the red phosphor powder region 332, and the following arrangements are proceeded in the same sequence.

The color filter 336b is similarly disposed on the phosphor powder layer 328b and is adjacent to the phosphor powder layer 328b. In the color filter 336b, the green color filter regions 342 are respectively and correspondingly located on the green phosphor powder regions 334 of the phosphor powder layer 328b, the red color filter regions 340 are respectively and correspondingly located on the red phosphor powder regions 332, the yellow color filter regions 352 are respectively and correspondingly located on the yellow phosphor powder regions 350, and the blue light opening regions 338 or blue color filter regions are respectively and correspondingly located on the opening regions 330. In another word, the sizes and the positions of the green color filter regions 342, the red color filter regions 340, the yellow color filter regions 352, and the blue light opening regions 338 or blue color filter regions respectively correspond to the sizes and the positions of the underlying green phosphor powder regions 334, the red phosphor powder regions 332, the yellow phosphor powder regions 350 and the opening regions 330.

In the liquid crystal display 300b, the yellow powders have high energy conversion efficiency when the yellow powders are excited by the blue light 318, so that the brightness of the liquid crystal display 300b with the RGBY color system is higher than that of the liquid crystal display 300a with the RGB color system.

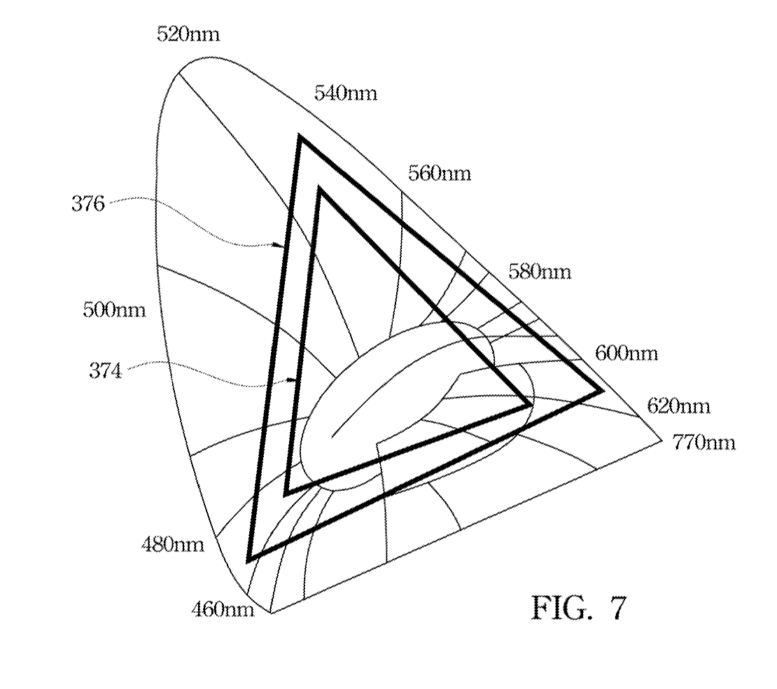

Refer to FIG. 7. FIG. 7 is a comparative diagram of color ranges of a liquid crystal display in accordance with another embodiment of the present invention and a conventional liquid, crystal display using white light light-emitting diodes. According to FIG. 5 and FIG. 7, it is known that a color range 376, which the liquid crystal display 300b can show, is obviously larger than the color range 374, which the conventional liquid crystal display using, the white light light-emitting diodes can show, and the color range 376 is also larger than the color range 372. Therefore, the color gamut of the liquid crystal display 300b is obviously superior to that of the conventional liquid crystal display using white light light-emitting diodes, and is also slightly superior to that of the liquid crystal display 300a.

According to the aforementioned embodiments of the present invention, it is known that the liquid crystal display of the present invention uses blue light-emitting diodes as light sources, so that a bin yield loss during packaging caused by using white light-emitting diodes is eliminated, and a utilization rate of the light-emitting diodes is increased, thereby reducing a fabrication cost of the liquid crystal display.

According to the aforementioned embodiments of the present invention, it is known that color purity of blue light-emitting diodes used as light sources in the liquid crystal display of the present invention is high, and a chromatic aberration problem is not occurred even the blue light emitted by the light-emitting diodes penetrates the entire light guide plate, so that a color distribution of the whole emitted light of the light guide plate is very uniform.

According to the aforementioned embodiments of the present invention, it is known that the liquid crystal display of the present invention does not need any blue color filter region, so that a fabrication cost is decreased, and optical efficiency of blue light of blue pixels is enhanced.

According to the aforementioned embodiments of the present invention, it is known that in the liquid crystal display of the present invention, while passing through green color filter regions, a conversion ratio from blue light to green light is increased by adjusting a concentration of green phosphor powders. Therefore, utilization efficiency and color purity of the green light are increased.

According to the aforementioned embodiments of the present invention, it is known that the light sources of the liquid crystal display of the present invention are not white light light-emitting diodes, so that phosphor powders do not contact with light-emitting diode chips, thereby can prevent the reaction of optical conversion efficiency, which is caused by heat generated while the light-emitting diode chips are operating.

According to the aforementioned embodiments of the present invention, it is known that a phosphor structure of the liquid crystal display of the present invention is composed of discontinuous phosphor dots rather than a phosphor powder layer covering a light guide plate. Therefore, the liquid crystal display has a small usage amount of phosphor materials and high luminescence efficiency.

According to the aforementioned embodiments of the present invention, it is known that the liquid crystal display of the present invention can prevent the optical contamination between the different colored lights of the adjacent pixels from occurring, so that the liquid, crystal display has higher color gamut.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A liquid crystal display, including:
a backlight module including:
a light guide plate; and
a plurality of blue light-emitting diodes adjacent to a side surface of the light guide plate to emit blue light toward the light guide plate through the side surface; and
a liquid crystal display panel disposed above a front surface of the backlight module, wherein the liquid crystal display panel includes:
a first transparent substrate disposed above the light guide plate;
a first electrode disposed on the first transparent substrate;
a liquid crystal layer disposed on the first electrode;
a phosphor powder layer disposed on the liquid crystal layer, wherein the phosphor powder layer includes a plurality of green phosphor powder regions and a plurality of red phosphor powder regions;
a color filter disposed on the phosphor powder layer and adjacent to the phosphor powder layer, wherein the color filter includes a plurality of green color filter regions and a plurality of red color filter regions respectively and correspondingly located on the green phosphor powder regions and the red phosphor powder regions;
a second electrode disposed on the color filter; and
a second transparent substrate disposed on the second electrode.

2. The liquid crystal display according to claim 1, wherein each of the first transparent substrate and the second transparent substrate is a glass substrate.

3. The liquid crystal display according to claim 1, wherein the phosphor powder layer further includes a plurality of opening regions, and the opening regions, the green phosphor powder regions and the red phosphor powder regions are staggered sequentially.

4. The liquid crystal display according to claim 3, wherein the color filter further includes a plurality of blue color filter regions respectively and correspondingly located on the opening regions.

5. The liquid crystal display according to claim 3, wherein the color filter further includes a plurality of blue light opening regions respectively and correspondingly located on the opening regions.

6. The liquid crystal display according to claim 1, wherein
the phosphor powder layer further includes a plurality of yellow phosphor powder regions and a plurality of opening regions, and the opening regions, the green phosphor powder regions, the red phosphor powder regions and the yellow phosphor powder regions are staggered sequentially; and
the color filter further includes a plurality of yellow color filter regions respectively and correspondingly located on the yellow phosphor powder regions.

7. The liquid crystal display according to claim 6, wherein the color filter further includes a plurality of blue color filter regions respectively and correspondingly located on the opening regions.

8. The liquid crystal display according to claim 6, wherein the color filter further includes a plurality of blue light opening regions respectively and correspondingly located on the opening regions.
